(19) United States
(12) Patent Application Publication
(10) Pub. No.: US 2026/0320630 A1
(43) Pub. Date: Oct. 15, 2026

(54) Artificial Intelligence (AI) Driven System for Predictive Carbon Management, Optimization and Trading of Energy credits

(71) Applicant: Akram Khalis, Kenilworth, NJ (US)

(72) Inventor: Akram Khalis, Kenilworth, NJ (US)

(21) Appl. No.: 19/532,331

(22) Filed: Feb. 6, 2026

Related U.S. Application Data
(60) Provisional application No. 63/756,008, filed on Feb. 7, 2025.
(60) Provisional application No. 63/755,976, filed on Feb. 7, 2025.
(60) Provisional application No. 63/755,335, filed on Feb. 7, 2025.

(51) Int. Cl. G06Q 30/018; G05B 13/02; G06Q 40/04; H02J 3/008; H02J 103/30; H02J 105/12

(52) U.S. Cl. CPC G06Q 30/018; G05B 13/0265; G06Q 40/049; H02J 3/008; H02J 2103/30; H02J 2105/12

(57) ABSTRACT

The present invention provides an artificial intelligence (AI) based system and method for tracking carbon footprints and managing carbon credits by integrating with carbon offsets and alerting module to notify the managers, operators and stakeholders for actionable insights. The system also allows real-time tracking, reporting, and optimizing sustainability metrics in smart buildings. The system leverages blockchain technology to record and verify energy credit transactions in a secure, tamper-proof manner.

### FIELD OF THE INVENTION

This application claims benefit of U.S. provisional patent application Ser. No. 63/756,008 filed Feb. 7, 2025, U.S. provisional patent application Ser. No. 63/755,976 filed Feb. 7, 2025, and U.S. provisional patent application Ser. No. 63/755,335 filed Feb. 7, 2025. The aforementioned related patent applications are herein incorporated by reference in their entirety.

### FIELD OF THE INVENTION

The present invention generally relates to the field of carbon management and sustainability of the building. More particularly, the present invention relates to an artificial intelligence (AI) based system and method for tracking carbon footprints, managing carbon credits and offsets, and optimizing energy usage through hybrid power systems. The present invention relates to a blockchain enabled based trading blockchain-based platform designed to enable secure and transparent trading of energy credits within smart building networks.

### BACKGROUND OF THE INVENTION

Buildings are among the largest contributors to global carbon emissions due to their high energy consumption for heating, cooling, lighting, and other operations. Despite increasing regulatory and market pressures to reduce emissions, existing building management systems lack predictive capabilities to manage and optimize carbon footprints. Current approaches of carbon management rely on static reports and manual adjustments that are reactive and inefficient. Thus, there is a growing need for intelligent systems that can provide real-time forecasts and tailored recommendations to help organizations meet sustainability targets.

Modern buildings contribute significantly to global energy consumption and carbon emissions. As smart building technologies evolve, there is increasing demand for tools that provide actionable insights into energy efficiency and sustainability metrics. While energy management systems exist, they often lack robust real-time carbon tracking, actionable recommendations, and stakeholder-focused reporting mechanisms.

As renewable energy adoption increases, many buildings generate surplus energy through solar panels, wind turbines, or other sources. However, there is often no transparent or efficient mechanism for trading excess energy with other buildings or entities. Traditional energy markets rely on intermediaries and centralized systems that can introduce delays, increase costs, and limit scalability. Blockchain technology offers a solution by providing an immutable, decentralized ledger that enables secure and transparent transactions. AI-driven optimization can further enhance transaction efficiency by dynamically balancing supply and demand.

A CN Patent CN117495119A assigned to Zhejiang University of Technology ZJUT discloses an intelligent prediction method of carbon emissions during building operation using a neural network optimization algorithm. Although, the patent discloses a neural network optimization algorithm that can predict and calculate the daily carbon emissions of a building based on a neural network optimization algorithm, thereby providing building operators with strategic suggestions for reducing carbon emissions.

However, the patent fails to disclose automated control of HVAC systems, lighting controls, renewable sources operations. Additionally, the patent fails to disclose formation of sustainable metric that provide information about the carbon credit and carbon offsets. The patent also fails to disclose trading of the carbon credits.

Another US Publication US20250322414 assigned to Carbonquest Inc describes carbon management systems and carbon optimization systems for managing combustion of a carbon resource to produce flue gas, and carbon dioxide separation, purification, and transport of the purified carbon dioxide from a plurality of distinct combustion sources. Although, the carbon optimization system also includes a reinforced machine learning, or RML, interpreter that is an algorithm that calculates reward based on action results. The reward can be in the form of carbon credits awarded to the building itself. However, the patent fails to disclose automated control of electrical equipment such as HVAC systems, lighting controls, renewable sources operations. Additionally, the patent also fails to disclose trading of the carbon credits.

Another PCT Published application WO2024226848A2 assigned to Strong Force Ee Portfolio 2022 LLC discloses an Al-based energy edge platform is provided herein with embodiments that may forecast, plan for, and manage the demand and utilization of energy in greater distributed environments. Embodiments may employ intelligent provisioning, data aggregation, and analytics to leverage energy market connection, communication, and transaction enablement platforms. However, the patent fails to disclose automated control of HVAC systems, lighting controls, renewable sources operations. Additionally, the patent also fails to disclose trading of the carbon credits.

Existing Building Management Systems (BMS) often focus on immediate operational efficiency such as maintaining temperature or lighting without a direct, real-time link to carbon emissions or regulatory sustainability frameworks. As global regulations (e.g., LEED, WELL, CSRD) become more stringent, there is a critical need for a system that not only manages energy but also translates that energy data into actionable carbon metrics, credits, and tradeable assets on a single platform allowing carbon management and carbon credit trading to support compliance with sustainability goals and regulations.

The aforementioned system fails to solve a key problem of the collective system incorporating the carbon footprints and carbon credits evaluation system. However, current platforms rely only on either on collection of the carbon emission and the sensor data for real-time energy consumption of an infrastructure including building, monuments and alike.

Consequently, there is an unmet need for a single AI based system that collectively tracks carbon footprints, manages carbon credits and carbon offsets, and optimizes the energy usage through hybrid power systems. Additionally, the AI based system incorporates blockchain enabled based trading platform designed to enable secure and transparent trading of energy credits within smart building networks.

Therefore, the present invention fills the gap by offering a comprehensive system that tracks carbon savings, reports energy consumption, generates sustainability metrics in real-time, and suggests energy-saving measures using AI. Further, by integrating carbon offset tracking, the system helps the buildings to align with sustainability regulations and corporate environmental goals.

It is apparent now that numerous methods and systems are developed in the prior art that are adequate for various purposes. Furthermore, even though these inventions may be suitable for the specific purposes to which they address. Accordingly, they would not be suitable for the purposes of the present invention as heretofore described. Thus, there is a need to provide an artificial intelligence (AI) driven system for predictive carbon management, optimization and trading of energy credits to forecast carbon emissions from building operations and provide actionable recommendations to building manager for reduce energy consumption. Additionally, the present invention provides building automation control unit for automated control of HVAC, lighting and electrical equipment. Additionally, the present invention awards energy credits to the building and allows secure and tamperproof trading of the energy credits over a blockchain enabled AI platform.

### SUMMARY OF THE INVENTION

The present invention provides a system for an artificial intelligence (AI) based carbon tracking and management system to generate a sustainability metric for visualizing carbon footprints, carbon credits and carbon offsets for optimizing energy usage of one or more resources in a building. The artificial intelligence (AI) based carbon tracking and management system includes a sensor unit with a number of sensors that are configured to collect a real-time data based on one or more of environmental conditions, occupancy, energy usage, energy consumption, temperature, renewable energy sources, DC Systems, AC systems and natural light levels within the building.

The artificial intelligence (AI) based carbon tracking and management system includes an AI controller that is centered around a data processor for receiving data from a sensor unit and processing the real-time data to generate a processed data. Further, the AI Controller utilizes a machine learning engine powered by one or more Large Language Models (LLMs). Unlike traditional algorithms, the LLM-based machine learning engine analyzes complex, unstructured historical data alongside the processed data in real-time to determine a baseline emission rate of the carbon. The baseline emission rate updates dynamically in real-time based on changes in the local utility grid's energy mix of the building. This ensures that the carbon footprint is calculated against the most current carbon intensity of the power source.

The AI controller is deployed in a hybrid-cloud architecture for providing a streamlined approach to compliance and allow real-time edge processing of the sensor data and further cloud-based aggregating of the ESG reporting across a portfolio of buildings. The AI controller continuously updates the machine learning engine based on collection of data in real-time to improve prediction accuracy. The central AI controller is responsible for analyzing data and generating forecasts carbon emission and recommendations to reduce the carbon emission. The AI module continuously updates its machine learning models based on new data to improve prediction accuracy in real-time.

The artificial intelligence (AI) based carbon tracking and management system includes a carbon evaluating unit operatively connected to the AI controller. The carbon evaluating unit includes a carbon emission forecasting module for forecasting and predicting future carbon emissions based on the baseline emission rate and occupancy trends to generate the carbon footprints of the building.

Further, the carbon evaluating unit includes a carbon credit generating module for generating the carbon credits based on the carbon emissions, the carbon footprints and a regulatory compliance document. The carbon credit generating module validates carbon savings against regulatory compliance documents such as but not limited to Sustainability Accounting Standards Board (SASB) ensuring the carbon credits that meet industry-specific sustainability benchmarks, and Corporate Sustainability Reporting Directive (CSRD) that aligns generated carbon credits with European Union transparency and reporting mandates to generate carbon credits.

Further, the carbon evaluating unit includes a carbon offset module for tracking and integrating the carbon offsets with the carbon credits. By anchoring the carbon credits to these specific regulatory standards such as LEED for reducing operating costs to improve efficiency. The carbon offsets integrated according to WELL certification to enhance productivity and improve health. The carbon offsets often seen as a key differentiator for ensuring that the resulting carbon credits possess high integrity and are “audit-ready” for international carbon markets. The system tracks key performance indicators (KPIs) relevant to ESG reporting. The carbon offset module manages the lifecycle of carbon credits and purchasing external carbon offsets via a digital interface to meet corporate Net-Zero targets. The carbon offset module configured to manage lifecycle of the carbon credits earned via energy efficiency and further allocation of the carbon offsets for regulatory compliance to business and stakeholders.

The artificial intelligence (AI) based carbon tracking and management system includes a sustainability metric generating unit operatively connected with the carbon evaluating unit. The sustainability metrics generating unit includes a zone defining module for defining one or more zones within the building. The sustainability metrics generating unit includes a report generating module for generating a report focusing on the carbon emissions, the carbon footprints, the carbon credits and the carbon offsets within the one or more zones of the building. The sustainability metrics generating unit includes a metric generating module for generating the sustainable metric based on the report.

Further, the artificial intelligence (AI) based carbon tracking and management system further includes a user interface that is a dynamic dashboard for providing building managers with real-time insights, forecasts, and actionable recommendations. Based on the forecasts and recommendation provided on the user interface, the system generates recommendations for reducing energy consumption such as but not limited to optimizing HVAC schedules to match occupancy, adjusting lighting based on daylight availability, implementing preventive maintenance to improve equipment efficiency. In one embodiment of the present invention, the recommendations are prioritized by their potential impact on carbon reduction and cost savings. The predictions help building managers to proactively adjust operations for reducing carbon output.

The system includes automated reporting tools to generate compliance documentation for reducing administrative workload. In one embodiment of the present invention, continuous data collection from the sensor unit allows the system to adapt to changing conditions in real-time. In one embodiment of the present invention, the system generates alerts to notify building managers of deviations from sustainability targets or unexpected energy spikes. The actionable recommendations are prioritized based on their potential impact on carbon reduction and cost savings. The alerts are generated to notify building managers of deviations from carbon reduction targets. The integration of the system with external data sources and sensors, including weather forecasts and energy pricing, to enhance prediction accuracy. The carbon emission data is visualized through interactive dashboards for supporting real-time monitoring and decision-making about the carbon reduction.

A primary objective of the present invention is to provide a scalable, adaptive and user-centric system for improving energy efficiency and reduces carbon footprints in modern smart buildings.

An objective of the present invention is to provide a system that allows sustainability tracking and energy optimization in smart buildings for monitoring carbon savings, reporting energy efficiency metrics, and integrating carbon offset tracking into building operations to helps buildings align with sustainability regulations and corporate environmental goals.

Another objective of the present invention is to provide a system to generate real-time visualizations and detailed reports of energy consumption and carbon savings for stakeholders.

Yet another objective of the present invention is to provide a system that incorporates carbon offset tracking by managing carbon credits earned through renewable energy usage and energy efficiency improvements.

Another objective of the present invention is to provide a system that provides tools to purchase, allocate and track carbon offsets for regulatory compliance or corporate goals.

Yet another objective of the present invention is to provide a system that adapts to various building types and operational needs, from residential to commercial applications.

In one embodiment of the present invention, the present invention provides the sensor unit that includes sensors for monitoring external weather forecasts and energy pricing of the DC systems, the AC systems, occupancy and the renewable energy sources. In one exemplary embodiment of the present invention, the DC system includes monitoring of energy distribution from the renewable energy sources to localized DC microgrids of the building to minimize conversion losses. Additionally, the sensor unit includes specialized DC-power meters configured to measure efficiency of direct-current lighting and EV-charging infrastructure.

In one another embodiment of the present invention, the present invention provides a carbon offset module to manage lifecycle of the carbon credits that are earned via energy efficiency and further the carbon offsets are allocated for regulatory compliance to business and stakeholders.

In one embodiment of the present invention, the present invention provides the building automation control unit for automated adjustments of the HVAC, scheduling lighting dimming schedules based on daylight harvesting, and setting prioritization of renewable energy discharge during peak emission periods from the renewable energy sources.

In one another embodiment of the present invention, the present invention provides the user interface is a dynamic dashboard to visualize the carbon emissions, the carbon credits and the carbon offsets along with a carbon intensity and a resource efficiency partitioned within the one or more zones of the building.

In one embodiment of the present invention, the present invention provides an AI controller configured to identify equipment inefficiencies through anomaly detection and suggest preventive maintenance to restore optimal carbon performance and minimizes the carbon emissions. The AI controller continuously updates the machine learning engine based on collection of data in real-time to improve prediction accuracy.

In one another embodiment of the present invention, the present invention provides an alerting module for triggering automated alerts and notifications for notifying when real-time carbon emissions deviate from a pre-defined ESG target or carbon budget defined in the regulatory compliance document with respect to the carbon emissions of the building. The automated alert module configured to notify a building operator when the carbon emission forecast exceeds a pre-defined monthly carbon budget.

In one embodiment of the present invention, the present invention provides a carbon offset integration module comprising a digital interface for the purchasing, allocation, and tracking of external carbon offsets to meet corporate sustainability objectives.

In one another embodiment of the present invention, the present invention provides an AI controller that is deployed in a hybrid-cloud architecture that allows real-time edge processing of the sensor data and cloud-based aggregate the ESG reporting across a portfolio of buildings.

In one embodiment of the present invention, the present invention provides the system that automatically validates the carbon credit eligibility based on calculated real-time carbon savings based on the carbon emissions and the carbon footprints.

In one another embodiment of the present invention, the present invention provides a recommendation module that is configured to interface with a building management system (BMS) to automatically execute operational adjustments without human intervention for operating the HVAC, the lights, and the renewable energy sources.

In one embodiment of the present invention, the present invention provides a carbon evaluating unit that includes a sustainable regulatory compliance module for generating the report compliance document to track key performance indicators (KPIs) relevant to Environmental, Social, and Governance (ESG) reporting to centralize, analyse, and visualize sustainability data to comply with regulations like LEED, WELL, CSRD, and SASB for determining the carbon credits.

In one another embodiment of the present invention, the system further includes a blockchain-based energy credit trading platform communicatively coupled to the carbon evaluating unit and the sensor unit. The blockchain-based energy credit trading platform includes a data integration unit configured to collect real-time energy production and energy consumption data derived from the sensor unit, further wherein the data integration unit integrate the real-time energy production and energy consumption data with the carbon credits to produce energy credits. The data integration unit is configured to collect real-time energy production and energy consumption utilizing one or more smart meters and one or more renewable energy generators.

The blockchain-based energy credit trading platform includes an energy trading AI unit in communication with the data integration unit. The energy trading AI unit includes a pricing module for deciding a base price based on a historical price and a transaction history. The energy trading AI unit further includes an AI optimization module for matching a number of buyers with a number of sellers based on the base price. The AI optimization module applies geographic proximity constraints for matching the buyers and the sellers of energy credits.

The energy trading AI unit further includes a transaction recording module for recording a transaction of the energy credits between a buyer and a seller. The energy trading AI unit further includes a decentralized ledger for validating the transaction of the energy credits between the buyer and the seller to generate a validated transaction. The energy trading AI module uses machine learning engine to predict supply and demand trends of the energy. The energy trading AI module operatively configured to continuously retrain using historical transaction data to improve trade matching accuracy. The AI optimization module prioritizes matching of energy credits based on time-sensitive availability windows.

The blockchain-based energy credit trading platform includes a privacy and compliance report generating unit for anonymizing the transaction and further generating a compliance report to meet regulatory requirements for trading the energy credits. The privacy and compliance report generating module encrypts transaction data prior to recording the transaction on the distributed or decentralized ledger network.

The blockchain-based energy credit trading platform includes a smart contract execution unit for automated execution and settlement of the validated transaction by transferring the energy credits to the buyer from the seller for trading the energy credits. The smart contract execution engine verifies availability of the energy credits prior to executing a trade between the buyer and the seller.

In one embodiment of the present invention, the blockchain-based energy credit trading platform includes the distributed ledger for ensuring transaction security and transparency through consensus mechanisms. The blockchain-based energy credit trading platform includes the pricing module that utilizes dynamic pricing models for deciding the base price to ensure fair and competitive trade rates. The blockchain-based energy credit trading platform includes a transaction recording module for recording transaction data is anonymized to protect privacy of the buyers and the sellers.

The blockchain-based energy credit trading platform further includes a notification module for alerting the buyers and the sellers of trade opportunities and market fluctuations. The blockchain-based energy credit trading platform is implemented as a permissioned blockchain that is accessible only to verified smart building participants. The blockchain-based energy credit trading platform dynamically modifies trade matching criteria based on historical transaction success rates. The energy credit transaction recorded on the distributed ledger network or the decentralized ledger network that includes metadata to identify an associated renewable energy source.

In one embodiment of the present invention, the blockchain-based energy credit trading platform supports partial fulfillment of the energy credit trades when a full requested amount is unavailable from a single seller. The system maintains an immutable audit trail linking each executed energy credit trade to corresponding energy production and consumption data.

In one embodiment of the present invention, the present invention provides an AI based carbon tracking and management method to generate a sustainability metric for visualizing carbon footprints, carbon credits and carbon offsets and optimizing energy usage of one or more resources of a building. Further, the method includes a step of collecting a real-time data based on one or more of environmental conditions, occupancy, energy usage, energy consumption, temperature, renewable energy sources, DC Systems, AC systems and natural light levels within the building. Further, the method includes a step of processing the real-time data to generate a processed data. Further, the method includes a step of analyzing the processed data and a historical data to determine a baseline emission rate. Further, the method includes a step of forecasting the carbon emissions of the building based on the baseline emission rate to generate the carbon footprints.

Further, the method includes a step of generating carbon credits based on the carbon emissions and a regulatory compliance document. Further, the method includes a step of integrating carbon offsets based on the carbon credits. Further, the method includes a step of defining one or more zones within the building. Further, the method includes a step of generating a report focusing on the carbon footprints, the carbon credits and the carbon offsets within the one or more zones of the building.

Further, the method includes a step of generating the sustainable metric based on the carbon footprints, the carbon credits and the carbon offsets. Further, the method includes a step of visualizing the carbon emissions, the carbon credits and the carbon offsets for the building. Further, the method includes a step of controlling the one or more resources of the building distributed within the one or more zones through a hybrid DC-AC power system based on the carbon footprints, the carbon credits and the carbon offsets. Further, the method includes a step of regulating heat, ventilation and air conditioning of the one or more resources within each of the one or more zones of the building.

Further, the method includes a step of controlling lighting and environmental conditions within each of the one or more zones of the building. Further, the method includes a step of adjusting the position of one or more shades based on the environmental conditions within each of the one or more zones of the building. Further, the method includes a step of optimizing the energy usage of the one or more resources in the building.

In one alternative embodiment of the present invention, the present invention provides an artificial intelligence (AI) based method for managing and trading energy credits of a building. Further, the method includes a step of collecting a real-time data based on one or more of environmental conditions, occupancy, energy usage, energy consumption, temperature, renewable energy sources, DC Systems, AC systems and natural light levels within the building. Further, the method includes a step of processing the real-time data to generate a processed data. Further, the method includes a step of analyzing the processed data and a historical data to determine a baseline emission rate.

Further, the method includes a step of forecasting carbon emissions to generate the carbon footprints of the building based on the baseline emission rate. Further, the method includes a step of generating the carbon credits based on the carbon emissions, the carbon footprints and a regulatory compliance document. Further, the method includes a step of collecting a real-time energy production and energy consumption data derived from the sensor unit. Further, the method includes a step of integrating the real-time energy production and energy consumption data with the carbon credits to produce energy credits.

Further, the method includes a step of deciding a base price based on a historical price and a transaction history. Further, the method includes a step of matching a number of buyers with a number of sellers based on the base price. Further, the method includes a step of recording a transaction of the energy credits between a buyer and a seller. Further, the method includes a step of validating the transaction of the energy credits between the buyer and the seller to generate a validated transaction. Further, the method includes a step of anonymizing the transaction to generating a compliance report to meet regulatory requirements. Lastly, the method includes a step of trading the energy credits by execution and settlement of the validated transaction by transferring the energy credits to the buyer from the seller.

Although the invention is described in terms of exemplary embodiments involving the modular architecture allows it to be adapted and extended to various educational, academic environments and teaching conditions.

The features described aforementioned can be applied individually or in combination across different embodiments, making the system highly scalable, secure, and efficient in transforming how smart educational system are managed through real-time automation and intelligent decision-making.

Other objectives and aspects of the invention will become apparent from the following detailed description, taken in conjunction with the accompanying drawings, which illustrate, by way for example, the features in accordance with embodiments of the invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

Although, the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being positioned upon illustrating principles. Furthermore, the drawings may contain text or captions that may explain certain embodiments of the present invention. This text is included for illustrative, non-limiting, explanatory purposes of certain embodiments detailed in the present invention. In the drawings:

Embodiments of the invention are described with reference to the following figures. The same numbers are used throughout the figures to reference like features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1(A) illustrates an artificial intelligence (AI) based carbon tracking and management system to generate a sustainability metric for visualizing carbon footprints, carbon credits and carbon offsets for optimizing energy usage of one or more resources in a building in accordance with the present invention;

FIG. 1(B) illustrates an artificial intelligence (AI) based system for managing and trading energy credits of a building in accordance with the present invention;

FIG. 2 illustrates a carbon evaluating unit for evaluating carbon footprints, carbon credits and carbon offsets with carbon offset integration module in accordance with the present invention;

FIG. 3 illustrates a sustainability metric generating unit for generating a sustainability metric for visualizing the carbon footprints, the carbon credits and the carbon offsets with a recommendation module in accordance with the present invention;

FIG. 4(A) illustrate a schematic diagram of a Blockchain-Based Energy Credit platform for Smart Buildings in accordance with the present invention;

FIG. 4(B) illustrates a schematic diagram of the Blockchain-Based Energy Credit platform showing a real-time trade between two buildings in a smart grid in accordance with the present invention;

FIG. 5(A) illustrates an artificial intelligence (AI) based carbon tracking and management method for the building in accordance with the present invention;

FIG. 5(B) illustrates an artificial intelligence (AI) based method for managing and trading energy credits in the building in accordance with the present invention.

### DETAILED DESCRIPTION OF THE INVENTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For the purpose of clarity, details relating to technical material that is known in the technical fields related to the invention have not been described in detail so as not to unnecessarily obscure the present invention.

In the description and claims of the application, each of the words “units” represents the dimension in any units such as centimeters, meters, inches, foots, millimeters, micrometer and the like and forms thereof, are not necessarily limited to members in a list with which the words may be associated.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items from the list. Finally, when used herein to join a list of items, “and” denotes “all of the items of the list.” The presence of broadening words and phrases such as “one or more,” “at least,” “but not limited to” or other like phrases in some instances shall not be read to mean that the narrower case is intended or required in instances where such broadening phrases may be absent.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present invention contains headers. It should be understood that these headers are used as references and are not to be construed as limiting upon the subjected matter disclosed under the header.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

As used herein, the term “module” may refer to, be part of, or include an ASIC, an electronic circuit, a processor (shared, dedicated, or group) and/or memory (shared, dedicated, or group) that execute one or more software or firmware programs, a combinational logic circuit, and/or other suitable components that provide the described functionality.

As used herein, the term “engine” may refer to, be part of, or include an ASIC, an electronic circuit, a processor (shared, dedicated, or group) and/or memory (shared, dedicated, or group) that execute one or more software or firmware programs, a combinational logic circuit, and/or other suitable components that provide the described functionality.

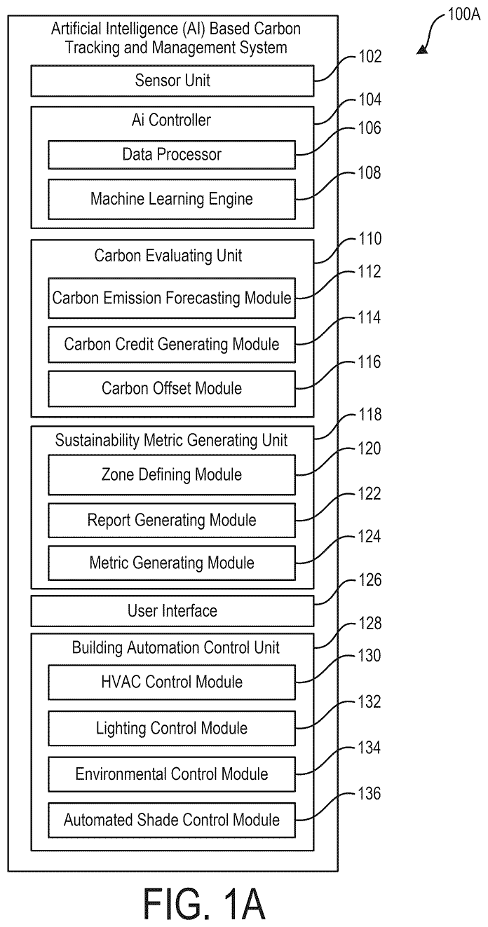

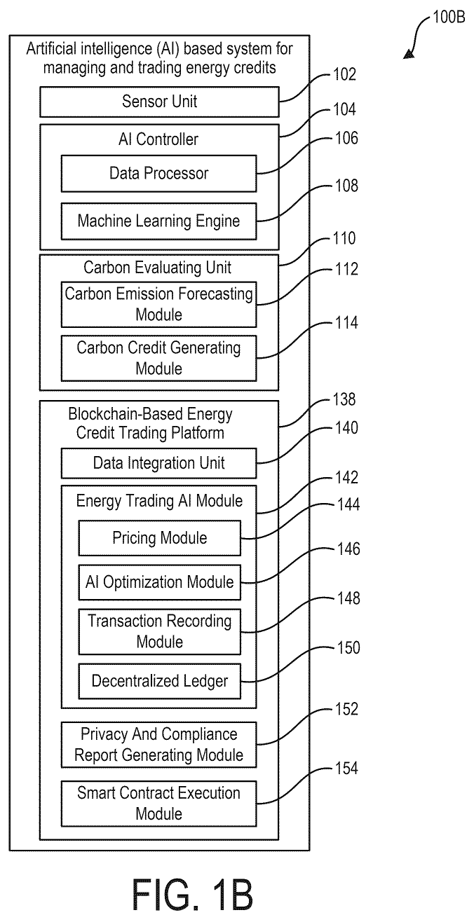

FIG. 1(A) illustrates an artificial intelligence (AI) based carbon tracking and management system (100A) to generate a sustainability metric for visualizing carbon footprints, carbon credits and carbon offsets for optimizing energy usage of one or more resources in a building. The artificial intelligence (AI) based carbon tracking and management system (100A) includes a sensor unit (102) with a number of sensors that are configured to collect a real-time data based on one or more of environmental conditions, occupancy, energy usage, energy consumption, temperature, renewable energy sources, DC Systems, AC systems and natural light levels within the building.

Further, the artificial intelligence (AI) based carbon tracking and management system (100A) includes an AI Controller (104) operatively connected to the sensor unit (102). The AI controller (104) includes a data processor (106) configured to process the real-time data to generate a processed data. Further, the AI Controller (104) includes a machine learning engine (108) based on one or more large language models (LLMs) and configured to analyze the processed data and a historical data to determine a baseline emission rate.

The AI Controller (104) utilizes a machine learning engine powered by one or more Large Language Models (LLMs) that analyzes complex, unstructured historical data alongside the processed data in real-time to determine a baseline emission rate of the carbon. The baseline emission rate is dynamic and this baseline emission rate updates dynamically in real-time based on changes in the local utility grid's energy mix of the building. This ensures that the carbon footprint is calculated against the most current carbon intensity of the power source.

The AI controller (104) is deployed in a hybrid-cloud architecture that allows real-time edge processing of the sensor data and cloud-based aggregate the sensor data based on the ESG reporting across a portfolio of buildings. The AI controller (104) continuously updates the machine learning engine based on collection of data in real-time to improve prediction accuracy.

Further, the artificial intelligence (AI) based carbon tracking and management system (100A) includes a carbon evaluating unit (110) operatively connected to the AI controller (104). The carbon evaluating unit (110) includes a carbon emission forecasting module (112) for forecasting carbon emissions to generate the carbon footprints of the building based on the baseline emission rate. Further, the carbon evaluating unit (110) includes a carbon credit generating module (114) for generating the carbon credits based on the carbon emissions, the carbon footprints and a regulatory compliance document.

The carbon credit generating module (114) validates carbon savings against regulatory compliance documents such as but not limited to e.g., Sustainability Accounting Standards Board (SASB) ensuring the carbon credits that meet industry-specific sustainability benchmarks; and Corporate Sustainability Reporting Directive (CSRD) that aligns generated carbon credits with European Union transparency and reporting mandates. to generate carbon credits. By anchoring the carbon credits to these specific regulatory standards, the module ensures that the resulting carbon credits possess high integrity and are “audit-ready” for international carbon markets.

Further, the carbon evaluating unit (110) includes a carbon offset module (116) for tracking and integrating the carbon offsets with the carbon credits. The invention provides a system and method for real-time tracking, reporting, and optimizing sustainability metrics in smart buildings.

Further, the artificial intelligence (AI) based carbon tracking and management system (100A) a sustainability metric generating unit (118) operatively connected with the carbon evaluating unit (110). The sustainability metrics generating unit (118) includes a zone defining module (120) for defining one or more zones within the building. The sustainability metrics generating unit (118) includes a report generating module (122) for generating a report focusing on the carbon emissions, the carbon footprints, the carbon credits and the carbon offsets within the one or more zones of the building. The sustainability metrics generating unit (118) includes a metric generating module (124) for generating the sustainable metric based on the report.

Further, the artificial intelligence (AI) based carbon tracking and management system (100A) includes a user interface (126) in communication with the sustainability metric generating unit (118) for visualizing the carbon footprints, the carbon credits and the carbon offsets of the building. Further, the artificial intelligence (AI) based carbon tracking and management system (100A) includes a building automation control unit (128) to control the one or more resources of the building distributed within the one or more zones through a hybrid DC-AC power system based on the carbon footprints, the carbon credits and the carbon offsets.

Further, the building automation control unit (128) includes an HVAC control module (130) for regulating heat, ventilation and air conditioning of the one or more resources within each of the one or more zones of the building. Further, the building automation control unit (128) includes a lighting control module (132) for controlling lighting within each of the one or more zones of the building. Further, the building automation control unit (128) includes an environmental control module (134) for controlling the environmental conditions within each of the one or more zones of the building. Further, the building automation control unit (128) includes an automated shade control module (136) for adjusting the position of one or more shades based on the environmental conditions within each of the one or more zones of the building for optimizing energy usage of the one or more resources in the building.

In one exemplary embodiment of the present invention, the artificial intelligence (AI) based carbon tracking and management system (100A) predicts that carbon emissions will exceed monthly targets due to an upcoming heatwave for a commercial building. The system acquires the real-time sensor data from the sensor unit (102) and AI Controller (104) process the real-time sensor data to forecast carbon emission about the upcoming heatwave. The system recommends pre-cooling of the building during off-peak hours to reduce peak energy consumption. The system also suggests adjusting lighting schedules in underutilized areas to save energy.

FIG. 1(B) illustrates an artificial intelligence (AI) based system (100B) for managing and trading energy credits (100B) of a building. The artificial intelligence (AI) based carbon management and trading system (100B) includes a sensor unit (102) with a one or more sensors configured to collect a real-time data based on one or more of environmental conditions, occupancy, energy usage, energy consumption, temperature, renewable energy sources, DC Systems, AC systems and natural light levels within the building.

Further, the artificial intelligence (AI) based carbon management and trading system (100B) an AI Controller (104) operatively connected to the sensor unit (102). The AI controller (104) includes a data processor (106) configured to process the real-time data to generate a processed data. Further, the AI controller (104) includes a machine learning engine (108) based on one or more large language models (LLMs) and configured to analyze the processed data and a historical data to determine a baseline emission rate.

Further, the artificial intelligence (AI) based carbon management and trading system (100B) includes a carbon evaluating unit (110) operatively connected to the AI controller (104). The carbon evaluating unit (110) includes a carbon emission forecasting module (112) for forecasting carbon emissions to generate the carbon footprints of the building based on the baseline emission rate. Further, the carbon evaluating unit (110) includes a carbon credit generating module (114) for generating the carbon credits based on the carbon emissions, the carbon footprints and a regulatory compliance document.

Further, artificial intelligence (AI) based carbon management and trading system (100B) includes a blockchain-based energy credit trading platform (138) communicatively coupled to the carbon evaluating unit (110) and the sensor unit (102). The blockchain-based energy credit trading platform (138) includes a data integration unit (140) configured to collect real-time energy production and energy consumption data derived from the sensor unit (102). The data integration unit (140) further integrates the real-time energy production and energy consumption data with the carbon credits to produce energy credits.

Further, the blockchain-based energy credit trading platform (138) includes an energy trading AI unit (142) in communication with the data integration unit. The energy trading AI unit (142) operatively configured to continuously retrain or update using historical transaction data to improve trade matching accuracy. The energy trading AI unit (142) includes a pricing module (144) for deciding a base price based on a historical price and a transaction history. Further, the energy trading AI unit (142) includes an AI optimization module (146) for matching a number of buyers with a number of sellers based on the base price. Further, the AI optimization module (146) applies geographic proximity constraints for matching the number of buyers and the number of sellers of energy credits. The AI optimization module (146) prioritizes matching of energy credits based on time-sensitive availability windows.

Further, the energy trading AI unit (142) includes a transaction recording module (148) for recording a transaction of the energy credits between a buyer and a seller. The transaction recording module (148) records transaction data and further anonymizes the transaction data to protect privacy of the number of buyers and the number of sellers.

Further, the energy trading AI unit (142) include a decentralized ledger (150) for validating the transaction of the energy credits between the buyer and the seller to generate a validated transaction. Further, the blockchain-based energy credit trading platform (138) includes a privacy and compliance report generating unit (152) for anonymizing the validated transaction and further generating a compliance report to meet regulatory requirements for trading the energy credits. The privacy and compliance report generating unit (152) encrypts transaction data prior to recording the transaction on the decentralized ledger network.

Further, the blockchain-based energy credit trading platform (138) includes a smart contract execution unit (154) for automated execution and settlement of the validated transaction by transferring the energy credits to the buyer from the seller for trading the energy credits. The smart contract execution engine (154) verifies availability of the energy credits prior to executing a trade between the buyer and the seller.

The blockchain-based energy credit trading platform (138) is implemented as a permissioned blockchain accessible only to verified smart building participants. The blockchain-based energy credit trading platform (138) dynamically modifies trade matching criteria based on historical transaction success rates. The energy credit transaction recorded on the decentralized ledger network includes metadata identifying an associated renewable energy source. The blockchain-based energy credit trading platform (138) supports partial fulfillment of the energy credit trades when a full requested amount is unavailable from a single seller. The system maintains an immutable audit trail linking each executed energy credit trade to corresponding energy production and consumption data.

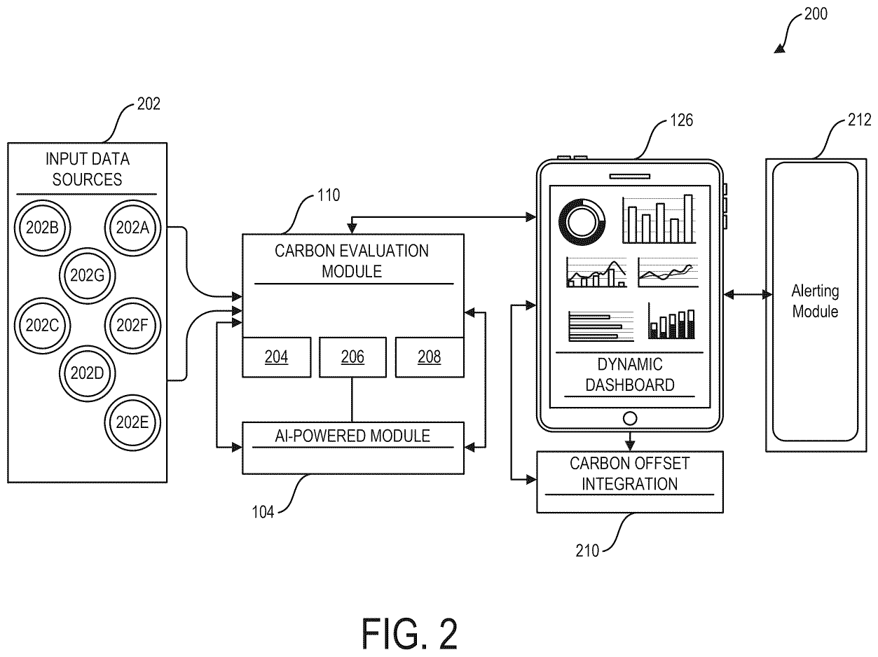

FIG. 2 illustrates an Artificial intelligence (AI) based carbon tracking and management system focusing on the carbon evaluating unit (110) to generate the carbon footprints (204), carbon credits (206) and carbon offsets (208) with a carbon offset integration module (210) and the alerting module (212) for notifying an authorized person over a user interface (126). The AI based system includes an input data source (202) comprising sensors (202A, 202B . . . 202N) including energy meters, HVAC and lighting control systems, occupancy sensors, and external data sensors such as weather forecasts and energy pricing for monitoring external weather forecasts and energy pricing of the DC systems, the AC systems, occupancy, renewable energy sources. sensors for monitoring external weather forecasts and energy pricing of the DC systems, the AC systems, occupancy and the renewable energy sources. Preferably, the DC system includes monitoring of energy distribution from the renewable energy sources to localized DC microgrids of the building to minimize conversion losses.

More specifically, the input data sources (202) include a sensor network for monitoring energy consumption in real-time. The sensor network includes sensors (202A) for monitoring consumption of renewable energy sources, sensors (202B) for detecting occupancy trends, sensors (202C) for consumption of energy from various energy sources, sensors (202D) for detecting DC Systems, sensors (202F) for tracking HVAC, ventilation and alike and sensors (202G) for detecting AC systems.

The carbon evaluating unit (110) includes a sustainable regulatory compliance module (204) for generating the report compliance document to track key performance indicators (KPIs) relevant to Environmental, Social, and Governance (ESG) reporting to centralize, analyse, and visualize sustainability data to comply with regulations like LEED, WELL, CSRD, and SASB for determining the carbon credits. The central AI powered module (206) operatively connected to the input data sources (202) and further responsible for analyzing data in real-time and predicting energy saving measures.

The carbon evaluating unit (110) connected to the input data sources (202) and the central AI powered module or AI controller (104) for processing energy saving measures, the real-time data from the sensors and a regulatory compliance document according green building certification standards such as LEED and WELL, enabling organizations to achieve sustainability and Environmental, Social, and Governance (ESG) goals. The carbon evaluating unit (110) aligns with popular green building certification programs, including LEED and WELL. The carbon evaluating unit (110) tracks key performance indicators (KPIs) relevant to ESG reporting as well.

The carbon evaluating unit (110) forecasts carbon emissions to generate the carbon footprints (204) of the building based on the baseline emission rate. The carbon evaluating unit (110) generates the carbon credits (206) based on the carbon emissions and further tracks and integrates the carbon offsets (208) with the carbon credits. The central AI powered module (206) updates the baseline emission rate dynamically based on changes in the local utility grid's energy mix. The central AI powered module or AI controller (104) automatically validates the carbon credit (206) eligibility based on calculated real-time carbon savings based on the carbon emissions and the carbon footprints. The carbon evaluating unit (110) automatically validates the carbon credit eligibility based on calculated real-time carbon savings based on the carbon emissions and the carbon footprints.

The carbon evaluating unit (110) further operatively connected to a User Interface (126) for visualizing the carbon footprints (204), the carbon credits (206) and the carbon offsets (208) of the building. The user interface (126) is a dynamic dashboard to visualize the carbon emissions, the carbon credits and the carbon offsets along with a carbon intensity and a resource efficiency partitioned within the one or more zones of the building.

The carbon evaluating unit (110) further operatively connected to a carbon offset integration module (210), which is a digital interface for the purchasing, allocation, and tracking of external carbon offsets to meet corporate sustainability objectives. The carbon offset integration module (210) integrates carbon offset tracking to help buildings meet regulatory compliance and corporate sustainability objectives. By integrating the carbon offsets, the system helps buildings align with sustainability regulations and corporate environmental goals,

The carbon evaluating unit (110) further operatively connected to an alerting module (212) for triggering automated alerts and notifications for notifying the building managers and authorized personnels, when real-time carbon emissions deviate from a pre-defined ESG target or carbon budget defined in the regulatory compliance document with respect to the carbon emissions of the building. The alerting module (212) configured to notify a building operator when the carbon emission forecast exceeds a pre-defined monthly carbon budget.

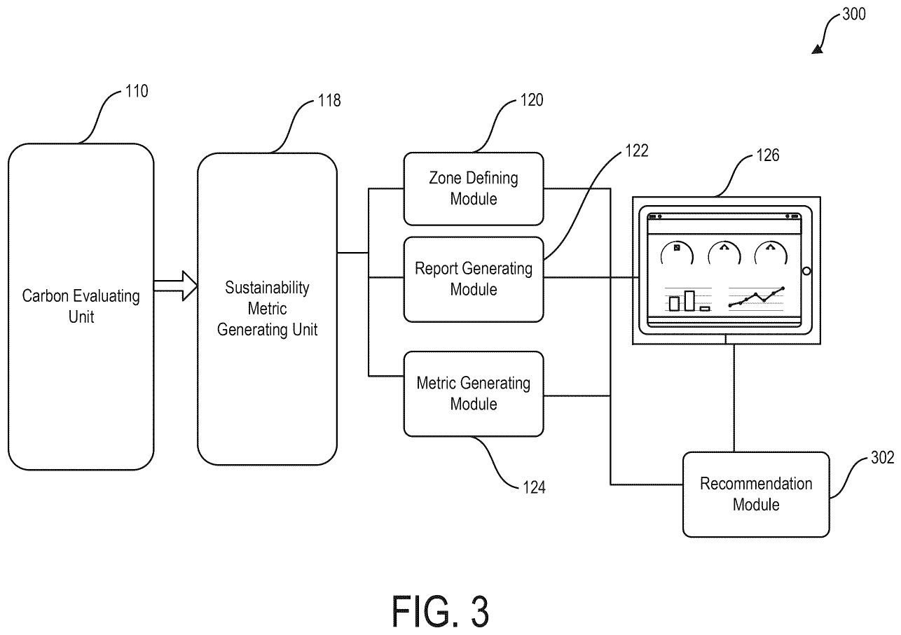

FIG. 3 illustrates a sustainability metric generating unit (118) for generating a sustainability metric for visualizing the carbon footprints, the carbon credits and the carbon offsets on the user interface (126) with a recommendation module (302). The sustainability metric generating unit (118) operatively connected with the carbon evaluating unit (110). The sustainability metrics generating unit (118) includes a zone defining module (120) for defining one or more zones within the building. The Sustainability Metric Generating Unit (110) partitions the building into specific Zones. By generating zone-specific reports, the system can identify which areas of a building are underperforming. This leads to the generation of a sustainability metric that is a proprietary score visualized on a User Interface (Dashboard) for showing carbon intensity and resource efficiency at a glance.

The sustainability metrics generating unit (118) includes a report generating module (122) for generating a report focusing on the carbon emissions, the carbon footprints, the carbon credits and the carbon offsets within the one or more zones of the building. The sustainability metrics generating unit (118) includes a metric generating module (124) for generating the sustainable metric based on the report. The sustainability metrics generating unit (118) operatively connected to a User Interface (126) in communication with the sustainability metric generating unit for visualizing the carbon footprints, the carbon credits and the carbon offsets within the one or more zones of the building.

The sustainability metrics generating unit (118) operatively a recommendation module (302) configured to interface with a building management system (BMS) or the building automation control unit (128) to automatically execute operational adjustments without human intervention for operating the HVAC, the lights, and the renewable energy sources.

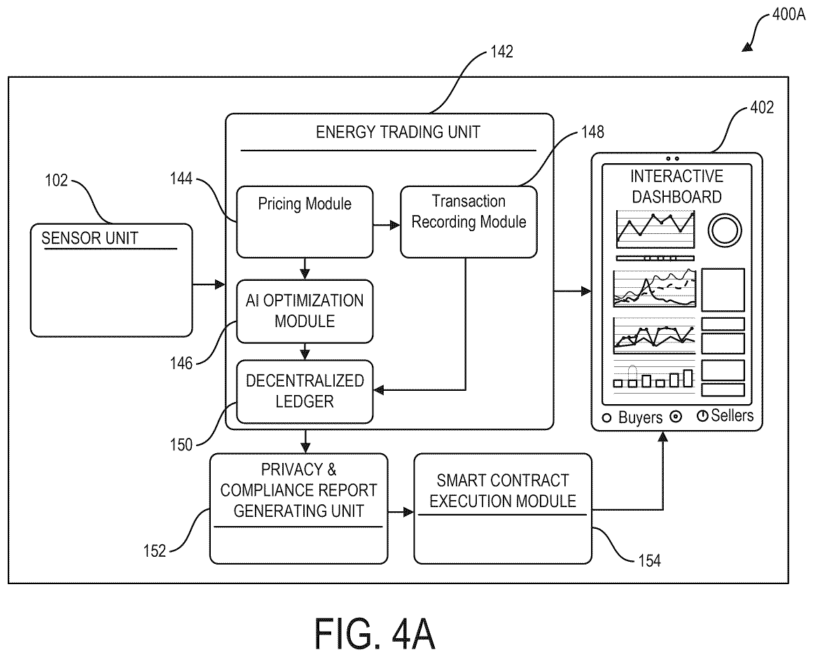

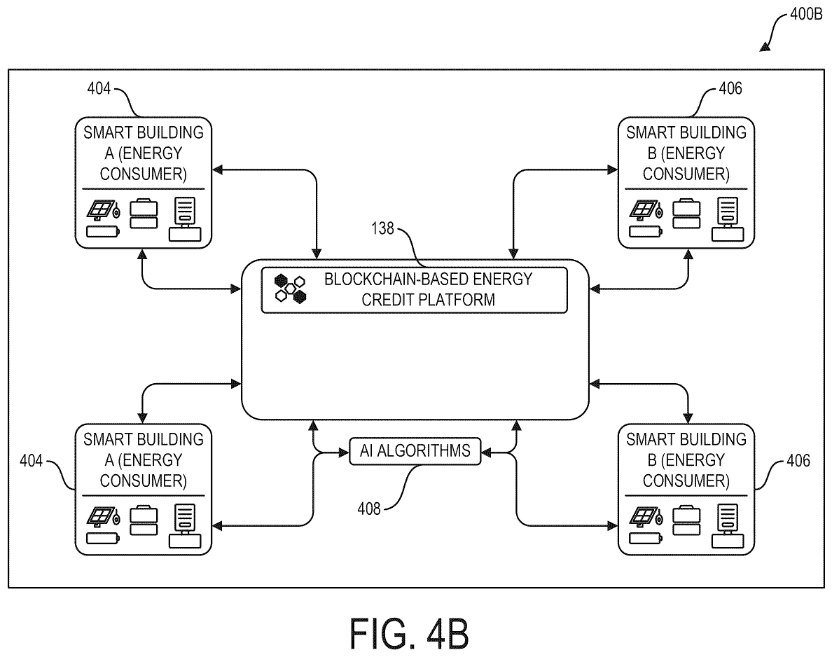

FIG. 4(A) illustrate a schematic diagram of a blockchain-based energy credit trading platform (138) for Smart Buildings. The blockchain-based energy credit trading platform (138) communicatively coupled to the carbon evaluating unit (110) and the sensor unit (102) that provides immediate insights into energy consumption and carbon savings.

The blockchain-based energy credit trading platform (138) includes a data integration unit (140) configured to collect real-time energy production and energy consumption data derived from the sensor unit (102). The data integration unit (140) integrate the real-time energy production and energy consumption data with the carbon credits to produce energy credits. The blockchain-based energy credit trading platform (138) further includes an energy trading AI unit (142) in communication with the data integration unit (140).

The energy trading AI unit (142) includes a pricing module (144) for deciding a base price based on a historical price and a transaction history. The energy trading AI unit (142) includes an AI optimization module (146) for matching a number of buyers with a number of sellers based on the base price. Further, the energy trading AI unit (142) includes a transaction recording module (148) for recording a transaction of the energy credits between a buyer and a seller.

Further, the energy trading AI unit (142) includes a decentralized ledger (150) for validating the transaction of the energy credits between the buyer and the seller to generate a validated transaction. The energy trading AI module (142) includes utilizes a Recurrent Neural Network (RNN) or Long Short-Term Memory (LSTM) model to forecast energy production based on historical weather patterns and building occupancy data. The energy trading AI unit (142) offers actionable recommendations for improving energy efficiency and achieving sustainability targets.

The blockchain-based energy credit trading platform (138) includes a privacy and compliance report generating unit (152) for anonymizing the transaction and further generating a compliance report to meet regulatory requirements for trading the energy credits. Further, the blockchain-based energy credit trading platform (138) includes a smart contract execution unit (154) for automated execution and settlement of the validated transaction by transferring the energy credits to the buyer from the seller for trading the energy credits. This module uses machine learning algorithms to match buyers and sellers based on factors such as energy availability, demand, and pricing.

The smart contract execution unit (154) includes predefined rules and conditions are encoded into smart contracts, which automatically execute trades when conditions are met. The AI optimization module (146) also analyzes historical and real-time data to predict energy demand and supply trends. The dynamic pricing models are applied to balance the marketplace within the pricing module (144), ensuring that energy credits are traded at fair and competitive rates. The smart contract execution unit (154) automate key processes including verification of energy credit availability, execution of trades once matching conditions are met, automatic settlement and transfer of credits between parties. These contracts reduce the need for manual intervention and minimize transaction delays. The system continuously learns from market behavior to improve matching accuracy and transaction efficiency.

The blockchain-based energy credit trading platform (138) includes an interactive dashboard (402) for visualizing the trade and further allowing the number of buyers and the number of sellers to access the historical prices, performance metrics and the transaction history for management and trading of the energy credits. The interactive dashboard (402) provides a stakeholder-focused reporting. The interactive dashboard (402) is a customizable dashboard that tailors the reports according to regulatory and corporate requirements.

The blockchain-based energy credit platform is a marketplace for smart buildings. The system leverages blockchain technology to record and verify energy credit transactions in a secure, tamper-proof manner. The AI algorithms analyze real-time data from energy production and consumption devices to optimize credit trades. The smart contract execution unit (154) automate the execution and settlement of transactions, thus reducing administrative overhead and ensuring compliance with predefined trading rules.

The blockchain-based energy credit marketplace is the secure platform in which transactions are recorded on a tamper-proof ledger, ensuring transparency and trust among participants. Each transaction includes metadata such as the amount of energy credits traded, the identities of the buyer and seller or anonymized identifiers, and the transaction timestamp. The blockchain network uses encryption and consensus protocols to secure transactions. Sensitive data, such as participant identities and transaction details, can be anonymized or encrypted to protect privacy.

In one embodiment of the present invention, a commercial office building generates excess solar energy during the day. The system matches this surplus generation of the solar energy with a nearby residential complex experiencing high energy demand. A smart contract executes the trade, transferring energy credits to the residential complex and updating the blockchain ledger.

FIG. 4(B) illustrates a schematic diagram of a real-time peer to peer energy trading and blockchain platform (400B) that utilizes blockchain and AI algorithms to facilitate real-time energy credit trading between distributed energy producers (Sellers) and consumers (buyers). The real-time peer to peer energy trading and blockchain platform (400) includes a smart building nodes comprising at least one Energy Producer (Smart Building A) (Seller) (404) and at least one Energy Consumer (Smart Building B) (Buyer) (406).

The Energy Producer (Smart Building A) (404) equipped with solar arrays and energy storage systems, The Energy Producer (Smart Building A) (404) node transmits real-time energy production data to the central marketplace or the central platform for analyzing or recording data. The Energy Consumer (Smart Building B) (406) generates a request for energy credits based on real-time consumption needs that exceed local production.

The blockchain-based energy credit platform (138) is a central and decentralized marketplace that serves as the settlement layer. The blockchain-based energy credit platform (138) records every transaction to ensure transparency and prevent double-spending of energy credits and executes smart contracts. The smart contract is executed that automates transactions when predefined conditions such as but not limited to price and volume matches are met.

The blockchain-based energy credit platform (138) cryptographically verifies information of the buyers, seller, Energy Producer and the Energy Consumer for ensuring that only authorized nodes offer or claim credits within the ecosystem. The blockchain-based energy credit platform (138) allows immediate transfer of energy credit tokens from producer (seller) to consumer (buyer) in exchange for value.

The blockchain-based energy credit platform (138) incorporates an AI algorithms module that sits between the physical building nodes and the blockchain marketplace. The AI algorithms (408) analyze historical transaction data and real-time production/consumption metrics to “Optimize Credit Trades”. The AI algorithms module generates Optimal Trading Instructions, ensuring energy flows and credit exchanges occur at maximum efficiency for stability of the grid.

The Smart Building A (404) offers energy credits based on surplus production. The Smart Building B (406) requests credits to meet a deficit of energy. The blockchain-based energy credit platform (138) verifies the transaction through smart contracts. The transaction history is updated on the ledger, and Real-Time Settlement occurs via the exchange of energy tokens.

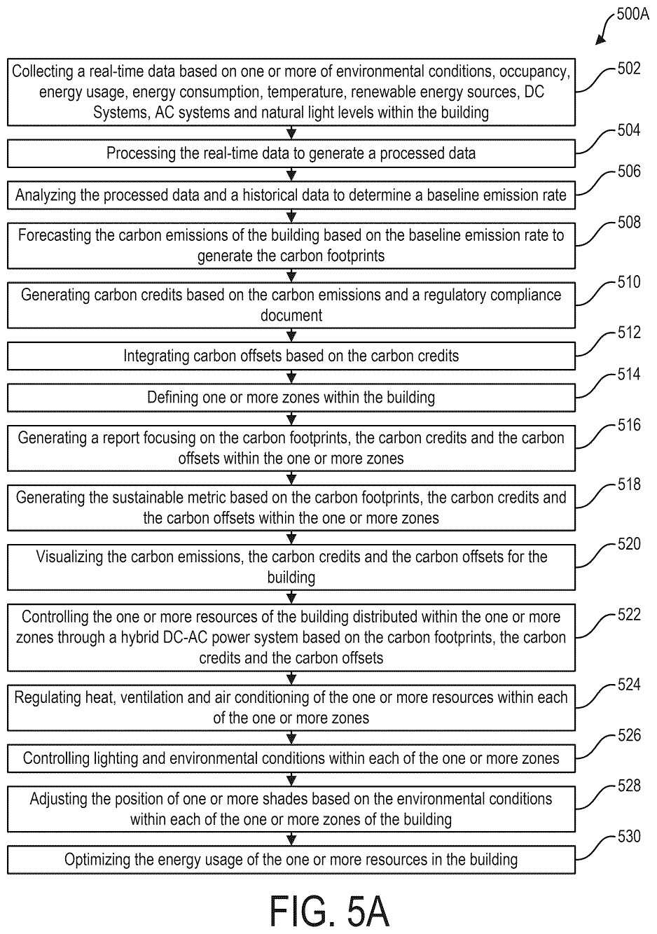

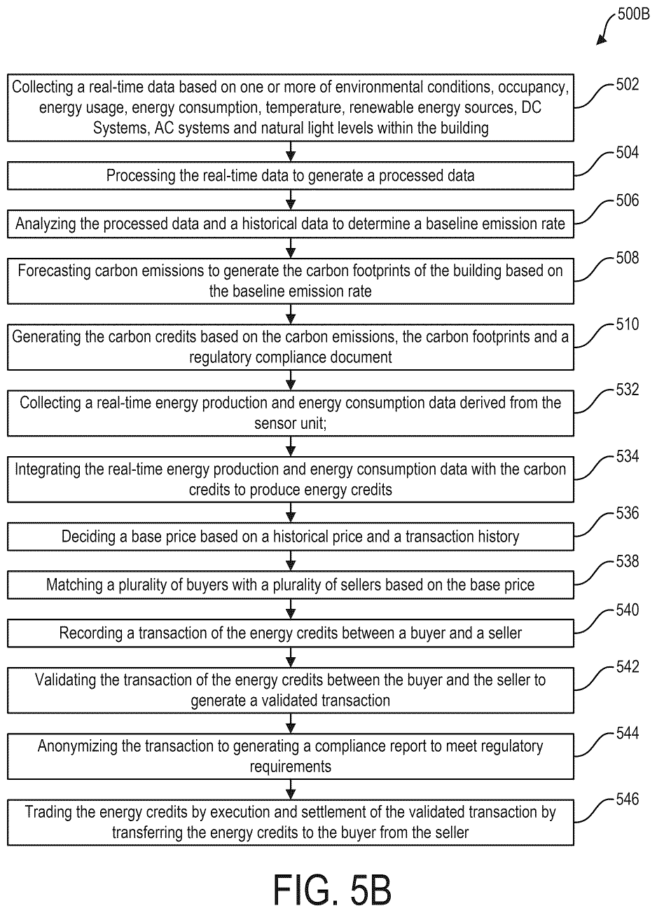

FIG. 5(A) illustrates an AI based carbon tracking and management method (500A) to generate a sustainability metric for visualizing carbon footprints, carbon credits and carbon offsets and optimizing energy usage of one or more resources of a building. The method (500A) includes a step (502) of collecting a real-time data based on one or more of environmental conditions, occupancy, energy usage, energy consumption, temperature, renewable energy sources, DC Systems, AC systems and natural light levels within the building. The method (500A) includes a step (504) of processing the real-time data to generate a processed data utilizing a data processor of the AI controller. Further, the method (500A) includes a step (506) of analyzing the processed data and a historical data to determine a baseline emission rate utilizing a machine learning engine. Further, the method (500A) includes a step (508) of forecasting the carbon emissions of the building based on the baseline emission rate to generate the carbon footprints. Further, the method (500A) includes a step (510) of generating carbon credits based on the carbon emissions and a regulatory compliance document. Further, the method (500A) includes a step (512) of integrating carbon offsets based on the carbon credits;

Further, the method (500A) includes a step (514) of defining one or more zones within the building. Further, the method (500A) includes a step (516) of generating a report focusing on the carbon footprints, the carbon credits and the carbon offsets within the one or more zones of the building. Further, the method (500A) includes a step (518) of generating the sustainable metric based on the carbon footprints, the carbon credits and the carbon offsets. Further, the method (500A) includes a step (520) of visualizing the carbon emissions, the carbon credits and the carbon offsets for the building. Further, the method (500A) includes a step (522) of controlling the one or more resources of the building distributed within the one or more zones through a hybrid DC-AC power system based on the carbon footprints, the carbon credits and the carbon offsets.

Further, the method (500A) includes a step (524) of regulating heat, ventilation and air conditioning of the one or more resources within each of the one or more zones of the building. Further, the method (500A) includes a step (526) of controlling lighting and environmental conditions within each of the one or more zones of the building. Further, the method (500A) includes a step (528) of adjusting the position of one or more shades based on the environmental conditions within each of the one or more zones of the building. Further, the method (500A) includes a step (530) of optimizing the energy usage of the one or more resources in the building.

FIG. 5(B) illustrates an artificial intelligence (AI) based method (500B) for managing and trading energy credits in a building. The AI based method (500B) comprising a step (502) of collecting a real-time data based on one or more of environmental conditions, occupancy, energy usage, energy consumption, temperature, renewable energy sources, DC Systems, AC systems and natural light levels within the building. The AI based method (500B) comprising a step (504) of processing the real-time data to generate a processed data using a data processor of the AI controller. Further, the AI based method (500B) includes a step (506) of analyzing the processed data and a historical data to determine a baseline emission rate. Further, AI based method (500B) includes a step (508) of forecasting carbon emissions to generate the carbon footprints of the building based on the baseline emission rate. Further, the AI based method (500B) includes a step (510) of generating the carbon credits based on the carbon emissions, the carbon footprints and a regulatory compliance document.

The AI based method (500B) comprising a step (532) of collecting a real-time energy production and energy consumption data derived from the sensor unit. Further, the AI based method (500B) includes a step (534) of integrating the real-time energy production and energy consumption data with the carbon credits to produce energy credits. Further, the AI based method (500B) includes a step (536) of deciding a base price based on a historical price and a transaction history using a pricing module of an energy trading AI unit. Further, the AI based method (500B) includes a step (538) of matching one or more buyers with one or more sellers based on the base price using an AI optimization module.

Further, the AI based method (500B) includes a step (540) of recording a transaction of the energy credits between a buyer and a seller using a transaction recording module of the energy trading AI unit. Further, the AI based method (500B) includes a step (542) of validating the transaction of the energy credits between the buyer and the seller to generate a validated transaction using a decentralized ledger of the energy trading AI unit.

Further, the AI based method (500B) include a step (544) of anonymizing the transaction to generating a compliance report to meet regulatory requirements. Further, the AI based method (500B) trading (546) the energy credits by automated execution and settlement of the validated transaction by transferring the energy credits to the buyer from the seller using a smart contract execution unit

While illustrative implementations of the application have been described in detail herein, it is to be understood that the inventive concepts may be otherwise variously embodied and employed, and that the appended claims are intended to be construed to include such variations, except as limited by the prior art.

Reference throughout this specification to “one implementation” or “an implementation” means that a particular feature, structure, or characteristic described in connection with the implementation is included in at least one implementation of the present invention. Thus, the appearances of the phrases “in one implementation” or “in some implementations” in various places throughout this specification are not necessarily all referring to the same implementation. Furthermore, the particular features, structures, or characteristics may be combined in any suitable manner in one or more implementations.

Systems and methods describing the present invention have been described. It will be understood that the descriptions of some embodiments of the present invention do not limit the various alternative, modified, and equivalent embodiments which may be include within the spirit and scope of the present invention as defined by the appended claims. Furthermore, in the detailed description above, numerous specific details are set forth to provide an understanding of various embodiments of the present invention. However, some embodiments of the present invention may be practiced without these specific details. In other instances, well known methods, procedures, and components have not been described in detail so as not to unnecessarily obscure aspects of the present embodiments.

1. An artificial intelligence (AI) based carbon tracking and management system to generate a sustainability metric for visualizing carbon footprints, carbon credits and carbon offsets for optimizing energy usage of one or more resources in a building, wherein the carbon tracking and management system comprising:
a sensor unit with a plurality of sensors configured to collect a real-time data based on one or more of environmental conditions, occupancy, energy usage, energy consumption, temperature, renewable energy sources, DC Systems, AC systems and natural light levels within the building;
an AI Controller operatively connected to the sensor unit, wherein the AI controller includes:
a data processor configured to process the real-time data to generate a processed data; and
a machine learning engine based on one or more large language models (LLMs) and configured to analyze the processed data and a historical data to determine a baseline emission rate;
a carbon evaluating unit operatively connected to the AI controller, wherein the carbon evaluating unit includes:
a carbon emission forecasting module for forecasting carbon emissions to generate the carbon footprints of the building based on the baseline emission rate;
a carbon credit generating module for generating the carbon credits based on the carbon emissions, the carbon footprints and a regulatory compliance document; and
a carbon offset module for tracking and integrating the carbon offsets with the carbon credits;
a sustainability metric generating unit operatively connected with the carbon evaluating unit, wherein the sustainability metrics generating unit includes:
a zone defining module for defining one or more zones within the building;
a report generating module for generating a report focusing on the carbon emissions, the carbon footprints, the carbon credits and the carbon offsets within the one or more zones; and
a metric generating module for generating the sustainable metric based on the report;
a User Interface in communication with the sustainability metric generating unit for visualizing the carbon footprints, the carbon credits and the carbon offsets of the building; and
a building automation control unit to control the one or more resources of the building distributed within the one or more zones through a hybrid DC-AC power system based on the carbon footprints, the carbon credits and the carbon offsets, wherein the building automation control unit includes:
an HVAC control module for regulating heat, ventilation and air conditioning of the one or more resources within each of the one or more zones;
a lighting control module for controlling lighting within each of the one or more zones;
an environmental control module for controlling the environmental conditions within each of the one or more zones; and
an automated shade control module for adjusting the position of one or more shades based on the environmental conditions within each of the one or more zones of the building for optimizing energy usage of the one or more resources in the building.

2. The system in accordance with claim 1, wherein the sensor unit includes one or more sensors for monitoring occupancy, the renewable energy sources, the AC systems and external weather forecasts and energy pricing of the DC systems.

3. The system in accordance with claim 1, wherein the DC system includes monitoring of energy distribution from the renewable energy sources to localized DC microgrids of the building to minimize conversion losses.

4. The system in accordance with claim 1, wherein the system further includes a carbon offset module with a digital interface for purchasing, allocating, and tracking of external carbon offsets to meet corporate sustainability objectives.

5. The system in accordance with claim 1, wherein the building automation control unit is configured for automated adjustments of the HVAC, scheduling lighting dimming based on daylight harvesting, and setting prioritization of renewable energy discharge during peak emission periods from the renewable energy sources.

6. The system in accordance with claim 1, wherein the user interface is a dynamic dashboard to visualize the carbon emissions, the carbon credits and the carbon offsets along with a carbon intensity and a resource efficiency partitioned within the one or more zones of the building.

7. The system in accordance with claim 1, wherein the AI controller configured to identify equipment inefficiencies through anomaly detection and suggest preventive maintenance to restore optimal carbon performance and minimizes the carbon emissions.

8. The system in accordance with claim 1, wherein the system further includes an alerting module for triggering automated alerts and notifications for notifying when real-time carbon emissions deviate from a pre-defined ESG target or carbon budget defined in the regulatory compliance document with respect to the carbon emissions of the building.

9. The system in accordance with claim 1, wherein the AI controller updates the baseline emission rate dynamically based on changes in the local utility grid's energy mix.

10. The system in accordance with claim 1, wherein the AI controller is deployed in a hybrid-cloud architecture, further wherein the AI controller is configured to allow real-time edge processing of the sensor data and aggregation of the sensor data based on the ESG reporting for a portfolio of buildings.

11. The system in accordance with claim 1, wherein the system automatically validates the carbon credits eligibility based on real-time calculation of carbon savings, the carbon emissions and the carbon footprints.

12. The system in accordance with claim 1, wherein the system further includes a recommendation module configured to connect with a building management system (BMS) to automatically execute operational adjustments without human intervention for operating the HVAC, the lights, and the renewable energy sources.

13. The system in accordance with claim 1, wherein the carbon evaluating unit includes a sustainable regulatory compliance module for generating the report compliance document to track key performance indicators (KPIs) relevant to Environmental, Social, and Governance (ESG) reporting to centralize, analyze, and visualize a sustainability data.

14. The system in accordance with claim 1, wherein the carbon credit generating module computes real-time carbon savings using the baseline emission rate, the carbon emissions and the regulatory compliance document.

15. The system in accordance with claim 1, wherein the system further includes a blockchain-based energy credit trading platform communicatively coupled to the carbon evaluating unit and the sensor unit, wherein the blockchain-based energy credit trading platform includes:
a data integration unit configured to collect real-time energy production and energy consumption data derived from the sensor unit, further wherein the data integration unit integrate the real-time energy production and energy consumption data with the carbon credits to produce energy credits;
an energy trading AI unit in communication with the data integration unit, wherein the energy trading AI unit includes:
a pricing module for deciding a base price based on a historical price and a transaction history;
an AI optimization module for matching a plurality of buyers with a plurality of sellers based on the base price;
a transaction recording module for recording a transaction of the energy credits between a buyer and a seller; and
a decentralized ledger for validating the transaction of the energy credits between the buyer and the seller to generate a validated transaction;
a privacy and compliance report generating unit for anonymizing the transaction and further generating a compliance report to meet regulatory requirements for trading the energy credits; and
a smart contract execution unit for automated execution and settlement of the validated transaction by transferring the energy credits to the buyer from the seller for trading the energy credits.

16. The system in accordance with claim 15, wherein the blockchain-based energy credit trading platform includes an interactive dashboard for visualizing the trade and allowing the plurality of buyers and the plurality of sellers to access the historical prices, performance metrics and the transaction history for trading of the energy credits.

17. The system in accordance with claim 15, wherein the blockchain-based energy credit trading platform further includes a notification module for alerting the plurality of buyers and the plurality of sellers of trade opportunities and market fluctuations.

18. An AI based carbon tracking and management method to generate a sustainability metric for visualizing carbon footprints, carbon credits and carbon offsets and optimizing energy usage of one or more resources of a building, wherein the method comprising:
collecting a real-time data based on one or more of environmental conditions, occupancy, energy usage, energy consumption, temperature, renewable energy sources, DC Systems, AC systems and natural light levels within the building;
processing the real-time data to generate a processed data;
analyzing the processed data and a historical data to determine a baseline emission rate;
forecasting the carbon emissions of the building based on the baseline emission rate to generate the carbon footprints;
generating carbon credits based on the carbon emissions and a regulatory compliance document;
integrating carbon offsets based on the carbon credits;
defining one or more zones within the building;
generating a report focusing on the carbon footprints, the carbon credits and the carbon offsets within the one or more zones;
generating the sustainable metric based on the carbon footprints, the carbon credits and the carbon offsets;
visualizing the carbon emissions, the carbon credits and the carbon offsets for the building;
controlling the one or more resources of the building distributed within the one or more zones through a hybrid DC-AC power system based on the carbon footprints, the carbon credits and the carbon offsets;
regulating heat, ventilation and air conditioning of the one or more resources within each of the one or more zones;
controlling lighting and environmental conditions within each of the one or more zones;
adjusting the position of one or more shades based on the environmental conditions within each of the one or more zones of the building;
optimizing the energy usage of the one or more resources in the building.

19. An artificial intelligence (AI) based system for managing and trading energy credits of a building, wherein the AI based system comprising:
a sensor unit with a plurality of sensors configured to collect a real-time data based on one or more of environmental conditions, occupancy, energy usage, energy consumption, temperature, renewable energy sources, DC Systems, AC systems and natural light levels within the building;
an AI Controller operatively connected to the sensor unit, wherein the AI controller includes:
a data processor configured to process the real-time data to generate a processed data; and
a machine learning engine based on one or more large language models (LLMs) and configured to analyze the processed data and a historical data to determine a baseline emission rate;
a carbon evaluating unit operatively connected to the AI controller, wherein the carbon evaluating unit includes:
a carbon emission forecasting module for forecasting carbon emissions to generate the carbon footprints of the building based on the baseline emission rate; and
a carbon credit generating module for generating the carbon credits based on the carbon emissions, the carbon footprints and a regulatory compliance document;
a blockchain-based energy credit trading platform communicatively coupled to the carbon evaluating unit and the sensor unit, wherein the blockchain-based energy credit trading platform includes:
a data integration unit configured to collect real-time energy production and energy consumption data derived from the sensor unit, further wherein the data integration unit integrate the real-time energy production and energy consumption data with the carbon credits to produce energy credits;
an energy trading AI unit in communication with the data integration unit, wherein the energy trading AI unit includes:
a pricing module for deciding a base price based on a historical price and a transaction history;
an AI optimization module for matching a plurality of buyers with a plurality of sellers based on the base price;
a transaction recording module for recording a transaction of the energy credits between a buyer and a seller; and
a decentralized ledger for validating the transaction of the energy credits between the buyer and the seller to generate a validated transaction;
a privacy and compliance report generating unit for anonymizing the transaction and further generating a compliance report to meet regulatory requirements for trading the energy credits; and
a smart contract execution unit for automated execution and settlement of the validated transaction by transferring the energy credits to the buyer from the seller for trading the energy credits.

20. An artificial intelligence (AI) based method for managing and trading energy credits of a building, wherein the AI based method comprising:
collecting a real-time data based on one or more of environmental conditions, occupancy, energy usage, energy consumption, temperature, renewable energy sources, DC Systems, AC systems and natural light levels within the building;
processing the real-time data to generate a processed data;
analyzing the processed data and a historical data to determine a baseline emission rate;
forecasting carbon emissions to generate the carbon footprints of the building based on the baseline emission rate;
generating the carbon credits based on the carbon emissions, the carbon footprints and a regulatory compliance document;
collecting a real-time energy production and energy consumption data derived from the sensor unit;
integrating the real-time energy production and energy consumption data with the carbon credits to produce energy credits;
deciding a base price based on a historical price and a transaction history;
matching a plurality of buyers with a plurality of sellers based on the base price;
recording a transaction of the energy credits between a buyer and a seller;
validating the transaction of the energy credits between the buyer and the seller to generate a validated transaction;
anonymizing the transaction to generating a compliance report to meet regulatory requirements; and
trading the energy credits by execution and settlement of the validated transaction by transferring the energy credits to the buyer from the seller.
